(19) United States
(12) Patent Application Publication
(10) Pub. No.: US 2026/0317489 A1
(43) Pub. Date: Oct. 15, 2026

(54) POLYMER RECYCLING PROCESS

(71) Applicant: Fina Technology, Inc., Houston, TX (US)

(72) Inventors: Michael A. McLeod, Houston, TX (US); Charline Fowler, Houston, TX (US); Kelly L. Bordelon, Deer Park, TX (US); Nicholas R. Reba, Houston, TX (US); Shazia N. Ullah, Houston, TX (US); Peng Li, Sugar Land, TX (US); Russell McDonald, Humble, TX (US); Jesse Ray Dillman, Alvin, TX (US); Keith E. Kelly, Tucson, AZ (US); Toby N. Stevens, League City, TX (US); Alyssa Henry, Houston, TX (US)

(73) Assignee: Fina Technology, Inc., Houston, TX (US)

(21) Appl. No.: 19/648,077

(22) Filed: Apr. 15, 2026

Related U.S. Application Data
(60) Provisional application No. 63/789,390, filed on Apr. 15, 2025.

(51) Int. Cl. C08J 3/00; C08J 11/06

(52) U.S. Cl. CPC C08J 3/005; C08J 11/06; C08J 2323/12

(57) ABSTRACT

A hybrid polymer composition comprising: (i) equal to or greater than about 10 wt. % of one or more mechanically recycled polymers and (ii) polypropylene wherein the polypropylene has a single melt history. A method of preparing a hybrid polymer composition comprising contacting a virgin polypropylene reactor powder with a mechanical recyclate polymer wherein the virgin polypropylene reactor powder has a single melt history.

### CROSS-REFERENCE TO RELATED APPLICATIONS

This application claims priority to U.S. Provisional Application No. 63/789,390 filed Apr. 15, 2025, and entitled “Polymer Recycling Process,” which is hereby incorporated herein by reference in its entirety for all purposes.

### STATEMENT REGARDING FEDERALLY SPONSORED RESEARCH OR DEVELOPMENT

Not applicable.

### TECHNICAL FIELD

The present disclosure relates generally to polymer compositions. More particularly, the present disclosure relates to mechanically recycled polymer compositions. Still more particularly, the present disclosure relates to hybrid polypropylene compositions containing mechanically recycled polymer.

### BACKGROUND

Polypropylene (PP) is a widely used plastic that has high modulus, high tensile strength, good heat resistance, and other favorable properties in the solid-state. Synthetic polymeric materials, particularly polypropylene resins, are manufactured into a variety of end-use articles ranging from medical devices to packaging materials.

The lifecycle of polymer materials starts with the raw materials, which are turned into a variety of products and components. At the end of life, the products are discarded as plastic waste, which is collected by waste disposal companies either separately or with general waste. An effective option for reducing plastic waste is to recycle these products. Recycling is the process of using recovered material to manufacture a new product and includes the combining of virgin polymer with recycled polymer to produce hybrid polymer compositions.

Conventional hybrid polymer production, however, has several deficiencies. The typical technique is to mix virgin polymer pellets with recyclate. Practitioners of the art normally do this by compounding, where a physical mixture of virgin polymer pellets and recyclate flake or pellets are melt mixed and re-extruded into a final pellet providing the advantage of creating a single pellet solution. Tradeoffs are significant though and can include quality and economic challenges as well as increased logistics costs due to transporting all components to a separate compounding facility.

Industrial-scale polyolefin extrusion typically is in line with the overall polymerization process, with intermediate steps between the polymer reactor and extruder often including a flashing or diluent removal step and short-term holding silos or other containers. Reactor powder is morphologically distinct when compared to extruded pellets that are typically shipped to customers.

Bulk density and powder morphology are important characteristics in industrial processes because they impact attributes like how the powders flow and are conveyed between operations. Driven by safety considerations, operational control and production economics, industrial operations are optimized around powder characteristics such as cohesive strength, frictional properties, bulk density, and angle of repose. Polyolefin industrial processes, including extrusion, are optimized around reactor powder characteristics.

Commercial compounding is typically performed using extruded pellets supplied by the polyolefin producer; this approach is representative of traditional hybrid single pellet production. These pellets are transported to the compounder via rail or truck. Such pellets are larger and more consistent pellet-to-pellet than reactor powder. Pelletization increases bulk density, improves handling characteristics and reduces shipping costs. The pellet size consistency can be important for customers because it can help enable consistent feeding and throughput on their processing equipment; for example, it is known that in some injection molding process inconsistencies in pellet size and shape can create non-uniformly melted resin and impact part yield. It is also known this can impact extrusion throughput at customers like third-party compounders. Pellet size can vary, but a typical size is approximately 3 mm. Thus, there is a broad need within polymer recycling for process improvement.

### BRIEF SUMMARY OF THE DISCLOSURE

Disclosed herein is a hybrid polymer composition comprising (i) equal to or greater than about 10 wt. % of one or more mechanically recycled polymers and (ii) polypropylene wherein the polypropylene has a single melt history.

Also disclosed herein is a method of preparing a hybrid polymer composition comprising contacting a virgin polypropylene reactor powder with a mechanical recyclate polymer wherein the virgin polypropylene reactor powder has a single melt history.

Also disclosed herein is a method comprising: extruding a virgin polymer pellet to produce an article; using and disposing of the article to produce a disposed article; recovering and cleaning the disposed article to form a cleaned article; shredding the cleaned article to form a shredded article regrinding the shredded article to form a regrind recyclate; contacting the regrind recyclate with a virgin polymer powder to form a mixture; and; extruding the mixture to form a hybrid extrusion wherein the virgin polymer pellet, the virgin polymer powder or both comprise polypropylene.

Aspects described herein comprise a combination of features and characteristics intended to address various shortcomings associated with certain prior devices, systems, and methods. The foregoing has outlined rather broadly the features and technical characteristics of the disclosed aspects in order that the detailed description that follows may be better understood. The various characteristics and features described above, as well as others, will be readily apparent to those skilled in the art upon reading the following detailed description, and by referring to the accompanying drawings. It should be appreciated that the conception and the specific aspects disclosed may be readily utilized as a basis for modifying or designing other structures for carrying out the same purposes as the disclosed aspects. It should also be realized that such equivalent constructions do not depart from the spirit and scope of the principles disclosed herein

### BRIEF DESCRIPTION OF THE DRAWINGS

For a detailed description of various exemplary aspects, reference will now be made to the accompanying drawings in which:

FIG. 1 is a process flow diagram depicting a general method of preparing a hybrid single pellet.

FIG. 2 is a process flow diagram depicting a method of the present disclosure for preparing a hybrid single pellet.

FIG. 3 is a plot of particle size percentage as a function of particle size for a virgin polypropylene pellet and a recyclate polypropylene pellet.

FIG. 4A is a plot of particle size percentage as a function of particle size for blends of a virgin polypropylene pellet and recyclate polypropylene pellet.

FIG. 4B is a plot of particle size percentage as a function of particle size for blends of a virgin polypropylene pellet and recyclate polypropylene pellet on a log scale.

FIG. 4C is a plot of particle size percentage as a function of particle size for polypropylene reactor powder and recyclate pellets.

FIG. 5A is a plot of particle size percentage as a function of particle size for blends of a virgin polypropylene powder and recyclate polypropylene pellet.

FIG. 5B is a plot of particle size percentage as a function of particle size for blends of a virgin polypropylene powder and recyclate polypropylene pellet on a log scale.

FIG. 6A is a bar graph of the Hunter B values of either a baseline blend or blend prepared using an improved process as a function of the number of extrusion passes.

FIG. 6B is a bar graph of the melt flow values of either a baseline blend or blend prepared using an improved process as a function of the number of extrusion passes.

FIG. 6C is a bar graph of the change in melt flow values of either a baseline blend or blend prepared using an improved process as a function of the number of extrusion passes.

FIG. 7A is a plot the D95/D5 as a function of D5 for the indicated samples.

FIG. 7B is a plot the D95/D5 as a function of D90/D10 for the indicated samples.

FIG. 7C is a plot the broad span as a function of D5 for the indicated samples.

FIG. 7D is a plot the broad span as a function of span for the indicated samples.

### DETAILED DESCRIPTION

The following discussion is directed to various exemplary aspects. However, one skilled in the art will understand that the examples disclosed herein have broad application, and that the discussion of any aspect is meant only to be exemplary of that aspect and not intended to suggest that the scope of the disclosure, including the claims, is limited to that aspect. Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. In addition, with respect to all ranges disclosed herein, such ranges are intended to include any combination of the mentioned upper and lower limits even if the particular combination is not specifically listed. All lists of values should be considered as inclusive of intermediate values unless the context indicates the contrary. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

In the following discussion and in the claims, the terms “including” and “comprising” are used in an open-ended fashion, and thus should be interpreted to mean “including, but not limited to . . . .” As used herein, the phrases “consist(s) of” and “consisting of” are used to refer to exclusive components of a composition, meaning only those expressly recited components are included in the composition; whereas the phrases “consist(s) essentially of” and “consisting essentially of” are used to refer to the primary components of a composition, meaning that only small or trace amounts of components other than the expressly recited components (e.g., impurities, byproducts, etc.) may be included in the composition. For example, a composition consisting of X and Y refers to a composition that only includes X and Y, and thus, does not include any other components; and a composition consisting essentially of X and Y refers to a composition that primarily comprises X and Y, but may include small or trace amounts of components other than X and Y. In aspects described herein, any such small or trace amounts of components other than those expressly recited following the phrase “consist(s) essentially of” or “consisting essentially of” preferably represent less than 5.0 wt. % of the composition, more preferably less than 4.0 wt. % of the composition even more preferably less than 3.0 wt. % of the composition, and still more preferably less than 1.0 wt. % of the composition. Use of broader terms such as comprises, includes, having, etc. should be understood to provide support for narrower terms such as consisting of, consisting essentially of, comprised substantially of, etc. Use of the term “optionally” with respect to any element of a claim is intended to mean that the subject element is required, or alternatively, is not required. Both alternatives are intended to be within the scope of the claim. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

The term “Mechanically Recycled Polymer” (MRP), as used herein, refers to a post-consumer or a post-industrial polymer that may be gathered, cleaned, and reclaimed as a feedstock for reuse to make new polymer articles. Generally, a mechanical recycling process involves the following phases (i) collection and sorting; (ii) cleaning; (iii) shredding; (iv) melt processing; and (v) pelletizing. MRP can take any suitable form such as granulated flake, powder from a grinding process, or formed pellets from taking recovered polymer and subjecting it to additional melt extrusion and pelletization steps. Using these techniques, MRP may be reprocessed into secondary raw materials without changing their chemical structure.

Recycled polymer (e.g., recycled polypropylene) is characterized as having experienced having undergone one or more previous melt cycles, for example, as a part of a melt extrusion process. Generally, recycled polymer usually was exposed to one or more melt extrusion steps, for example, where virgin polymer pellets were previously transformed into finished goods for the market, which are recycled to form the recycled polymer. A recycled polymer, as use in the present disclosure, may be distinguished from a virgin polymer based on the characteristics that are altered due in part to the thermal history and/or chemical composition of the recycled polymer.

In one or more aspects, a recycled polymer for use in this disclosure may have impurities (e.g., other polymers such as polyethylene, elastomers, or inorganic fillers, etc.) present in amounts ranging from about 0.1 wt. % to about 50 wt. %, additionally or alternatively from about 10 wt. % to about 50 wt. %, additionally or alternatively from about 20 wt. % to about 50 wt. % based on the total weight of the recycled polymer. In one or more aspects, the recycled polymer contains additives and/or impurities that were present when the recycled polymer was sourced. In one or more aspects, a recycled polymer for use in the present disclosure contains additives and/or impurities not found in a virgin polypropylene.

In one or more aspects, a recycled polymer for use in this disclosure may be characterized by an ash content level of from about 0.001 wt. % to about 0.5 wt. %. Ash refers to an inorganic remainder remaining after heating the polymer at high temperatures in the presence of various oxidizing agents to remove the presence of water and organic matter. Additionally or alternatively, in one or more aspects, recycled polymer is characterized by a polyethylene contamination of less than about 10 wt. % based on the weight of the recycled polymer, additionally and alternatively less than about 5 wt. %, additionally or alternatively less than about 1 wt. %. Compositional impurity (i.e., ash content and PE contamination level) is one of the main characteristics that distinguish recycled polymer from virgin resin.

Herein, the term “reactor polymer powder” refers to a product that is in the form of a granular powder yielded by a polymerization processes. This product is also referred to as a reactor polymer powder, reactor powder, or reactor fluff which is often shortened to “powder” or “fluff” out of expediency.

Virgin polymer powder is characterized by not having experienced a melt extrusion step before transformation into end-use articles. Virgin polymer pellets refer to a product made after transforming reactor polymer powder into a suitable form through melt extrusion; for example, transformation into pellets to make virgin polymer pellets. Virgin polymer pellets are traditionally shipped by polymer producers to customers, who then may melt-process the pellets to form end-use articles thereby imparting an additional extrusion history.

Herein, the term “hybrid polymer composition” refers to a polymer composition that consists of a mix of virgin polymer and recycled polymer. Hybrid polymer is typically prepared as a physical mixture of virgin polymer and recycled polymer that is melt-mixed on a molecular level in a compounding step, imparting an additional melt processing history. The normal process for making hybrid polymer pellets is by physically mixing virgin polymer pellets and recycled polymer at a third site (i.e., not where either the virgin polymer pellets are made or where the recycled polymer is collected).

Herein, the term “condensation polymer” refers to a polymer produced through a condensation reaction. These polymers can have their molecular weight manipulated (e.g., drying or addition of water). These polymers, such as polyesters and polyamides, are also called living polymers because their molecular weight is in dynamic equilibrium.

Disclosed herein are methods to produce hybrid polymer compositions having one or more improvements in polymer properties. In an aspect, the hybrid polymer composition displays an improved color when compared to an otherwise similar polymer composition whose components lack (i) a similar melt history and (ii) a similar particle size distribution. Hereinafter the otherwise similar polymer composition whose components lack (i) a similar melt history and (ii) a similar particle size distribution are referred to as the “reference composition.” Hereinafter relative properties of the hybrid polymer composition are in comparison to the reference unless otherwise stated.

In an aspect, the hybrid polymer composition displays an improved retention of higher molecular weight components (i.e., less alteration of molecular architecture). In an aspect, the hybrid polymer composition displays improved optical properties, such as a lower haze. In an aspect, the hybrid polymer composition displays an improved retention of rheological response, such as that measured by a melt indexer or other rheometry tools in response to multipass extrusion.

In an aspect, the hybrid polymer composition displays an improved antioxidant retention. An improved antioxidant retention may allow for the addition of a lesser amount of antioxidant to form a final composition meeting one or more user and/or process goals. In an aspect, the hybrid polymer composition can be prepared with reduced energy consumption. Herein, these compositions are collectively termed “improved hybrid polymer compositions” (IHPC).

In an aspect, the IHPC comprises (i) a recycled polymer and (ii) virgin polymer. At least a portion of the recycled polymer may be obtained from recycled polymer waste that has been mechanically recycled (i.e., MRP). Herein, the term “recycled polymer waste” is used to indicate a polymer material recovered from either post-consumer waste or post-industrial waste. In one or more aspects, the MRP is a post-consumer recycled resin or PCR. In one or more aspects, the MRP is a post-industrial recycled resin or PIR. PCR is obtained from objects having completed at least a first use cycle (or life cycle), for example, having already served their first purpose. PIR refers to resin obtained from manufacturing scrap which has not normally reached a consumer.

In one or more aspects, the polymer (recycled or virgin) is a thermoplastic. In other aspects, the thermoplastic is not a condensation polymer. In other aspects, the thermoplastic excludes a condensation polymer. In yet other aspects, the thermoplastic comprises greater than about 50% of a polyolefin such as polyethylene, polypropylene or polybutene. In other aspects, polypropylene comprises the majority of the polymer portion of the IHPC.

In one or more aspects, an IHPC comprises (i) a MRP and (ii) a virgin polymer wherein the MRP has x number of melt histories and the virgin polymer has y number of melt histories where x is equal to or greater than 3 and y is 1. Herein, a “polymer melt history” refers to the sequence of temperature changes and mechanical stresses a polymer has experienced throughout its processing.

Generally, polymers are processed via either melt processing or solution processing. In melt processing the polymer is heated until it reaches a molten, viscous state and subsequently formed into an article such as by extrusion or injection molding. Regarding solution processing, the polymer is dissolved in a liquid (solvent) to create a concentrated solution which can then be cast onto a surface or spun into threads. In either process the material is subject to changing temperatures, changing external and internal forces, and varying retention times; all of which contribute to the ultimate polymer structure.

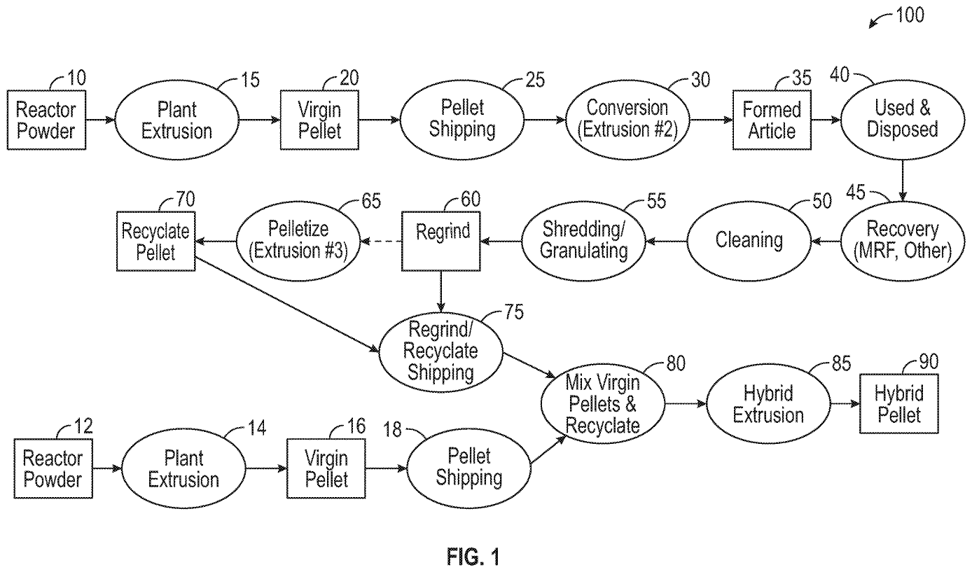

A general conventional method of preparing a hybrid single pellet 100 is presented in FIG. 1. With reference to FIG. 1, a recyclate begins with a reactor powder 10 which is subjected to plant extrusion 15 (first melt) to form a virgin pellet 20 which is shipped 25 to a consumer where it is converted 30 (e.g., via extrusion) to produce a second melt and formed into an article 35. The article may be then used, disposed of 40 and recovered 45. The recovered material 45 can then be cleaned 50, subjected to mechanical processing, such as an initial shred or granulation 55 to form shredded material. In the embodiment of FIG. 1, the shredded material is subjected to a regrind 60 to form a recyclate. The recyclate from the regrind 60 can either be extruded and pellitized 65 (third melt) to form a recyclate pellet 70 or the recyclate regrind can be shipped 75 to another site. A virgin pellet can be prepared starting with reactor powder 12 before being subjected to plant extrusion 14 to form the virgin pellet 16 which is subsequently shipped 18. At this point the shipped recyclate 75 and shipped virgin pellet 18 can be contacted to form a mixture of virgin pellet and recyclate 80. Extrusion of the mixture of virgin pellet and recyclate 80 is carried out to form a hybrid extrusion 85 which is subsequently formed into a hybrid pellet 90.

In one or more aspects, the polymeric portion of the IHPC comprises at least about 10 wt. % of a MRP based on the total weight of the IHPC, additionally or alternatively from about 10 wt. % to about 90 wt. %, additionally or alternatively from about 25 wt. % to about 75 wt. %, additionally or alternatively from about 30 wt. % to about 60 wt. %, additionally or alternatively about 12 wt. %, additionally or alternatively about 14 wt. %, additionally or alternatively about 16 wt. %, additionally or alternatively about 18 wt. %, additionally or alternatively about 20 wt. %, additionally or alternatively about 22 wt. %, additionally or alternatively about 24 wt. %, additionally or alternatively about 26 wt. %, additionally or alternatively about 28 wt. %, additionally or alternatively about 30 wt. %, additionally or alternatively about 32 wt. %, additionally or alternatively about 34 wt. %, additionally or alternatively about 36 wt. %, additionally or alternatively about 38 wt. %, additionally or alternatively about 40 wt. %, additionally or alternatively about 42 wt. %, additionally or alternatively about 44 wt. %, additionally or alternatively about 46 wt. %, additionally or alternatively about 48 wt. %, additionally or alternatively about 50 wt. %, additionally or alternatively about 52 wt. %, additionally or alternatively about 54 wt. %, additionally or alternatively about 56 wt. %, additionally or alternatively about 58 wt. %, additionally or alternatively about 60 wt. %, additionally or alternatively about 62 wt. %, additionally or alternatively about 64 wt. %, additionally or alternatively about 66 wt. %, additionally or alternatively about 68 wt. %, additionally or alternatively about 70 wt. %, additionally or alternatively about 72 wt. %, additionally or alternatively about 74 wt. %, additionally or alternatively about 76 wt. %, additionally or alternatively about 78 wt. %, additionally or alternatively about 80 wt. %, additionally or alternatively about 82 wt. %, additionally or alternatively about 84 wt. %, additionally or alternatively about 86 wt. %, additionally or alternatively about 88 wt. %, additionally or alternatively about 90 wt. %. In one or more aspects, the remainder of the IHPC polymeric portion comprises virgin polymer.

In one or more aspects, the polymeric portion of the IHPC comprises at least about 10% of a virgin polymer based on the total weight of the IHPC, additionally or alternatively from about 10 wt. % to about 90 wt. %, additionally or alternatively from about 25 wt. % to about 75 wt. %, additionally or alternatively from about 30 wt. % to about 60 wt. %, additionally or alternatively about 12 wt. %, additionally or alternatively about 14 wt. %, additionally or alternatively about 16 wt. %, additionally or alternatively about 18 wt. %, additionally or alternatively about 20 wt. %, additionally or alternatively about 22 wt. %, additionally or alternatively about 24 wt. %, additionally or alternatively about 26 wt. %, additionally or alternatively about 28 wt. %, additionally or alternatively about 30 wt. %, additionally or alternatively about 32 wt. %, additionally or alternatively about 34 wt. %, additionally or alternatively about 36 wt. %, additionally or alternatively about 38 wt. %, additionally or alternatively about 40 wt. %, additionally or alternatively about 42 wt. %, additionally or alternatively about 44 wt. %, additionally or alternatively about 46 wt. %, additionally or alternatively about 48 wt. %, additionally or alternatively about 50 wt. %, additionally or alternatively about 52 wt. %, additionally or alternatively about 54 wt. %, additionally or alternatively about 56 wt. %, additionally or alternatively about 58 wt. %, additionally or alternatively about 60 wt. %, additionally or alternatively about 62 wt. %, additionally or alternatively about 64 wt. %, additionally or alternatively about 66 wt. %, additionally or alternatively about 68 wt. %, additionally or alternatively about 70 wt. %, additionally or alternatively about 72 wt. %, additionally or alternatively about 74 wt. %, additionally or alternatively about 76 wt. %, additionally or alternatively about 78 wt. %, additionally or alternatively about 80 wt. %, additionally or alternatively about 82 wt. %, additionally or alternatively about 84 wt. %, additionally or alternatively about 86 wt. %, additionally or alternatively about 88 wt. %, additionally or alternatively about 90 wt. %. In one or more aspects, the remainder of the IHPC polymeric portion comprises MRP.

An IHPC may further comprise one or more additives to impart some user and/or process desired property to the composition. Nonlimiting examples of additives suitable for inclusion in the IHPC are colorants, cavitating agents, slip agents, antioxidants, anti-fog agents, anti-static agents, anti-block agents, fillers, moisture barrier additives, gas barrier additives, gas scavengers, neutralizers, nucleators, nucleation inhibitors, hindered amine light stabilizers, viscosity modifier, and combinations thereof. Such additives may be used singularly or in combination in effective amounts, which vary depending upon the property desired.

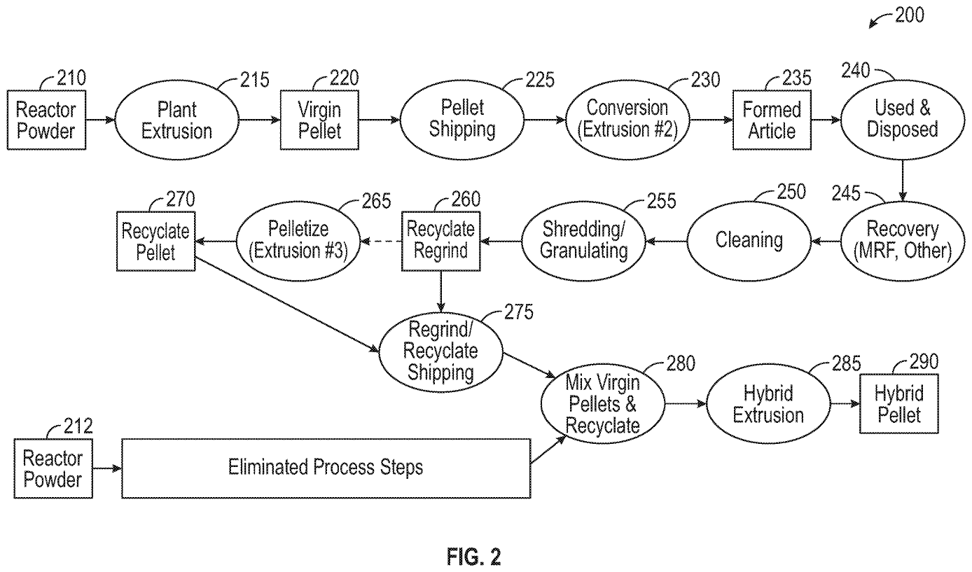

Disclosed herein are methods of preparing an IHPC 200 that is schematically depicted in FIG. 2. With reference to FIG. 2, recyclate production begins with a reactor powder 210 which is subjected to plant extrusion 215 (first melt) to form a virgin pellet 220 which is shipped 225 to a consumer where it is converted 230 via extrusion (second melt) and formed into an article 235. The article may be then used and disposed of 240 and recovered 245. The recovered material 245 can then be cleaned 250, subjected to an initial shredded or granulated 255, and then a regrind 260. The recyclate regrind 260 can either be extruded and pellitized 265 (third melt) to form a recyclate pellet 270 or the recyclate regrind can be shipped 275 to another site. In one or more aspects, a reactor powder 212 (i.e., virgin material) is mixed with the shipped recyclate 275 to form a mixture of virgin polymer powder and recyclate 280. Notably, in such aspects, the preparation of the IHPC 200 excludes extrusion of the reactor powder to from a virgin pellet that is subsequently shipped to a site having the recyclate. Extrusion of the mixture of virgin pellet and recyclate 280 is carried out to form a hybrid extrusion 285 which is subsequently formed into a hybrid pellet 290 (an IHPC).

In one or more aspects, from about 10 weight percent (wt. %) to about 90 wt. %, additionally or alternatively, from about 15 wt. % to about 85 wt. %, additionally or alternatively from about 20 wt. % to about 80 wt. % of the virgin polymer in the IHPC may comprise reactor powder (e.g., 210 or 212). Consequently, the aforementioned ranges refer to virgin polymer powder without a melt history prior to extrusion to form the IHPC. Powders tend to have more variability because they have greater friability than pellets and their sizes also depend on variables like reactor technology and catalyst activity.

In one or more aspects, equal to or greater than about 20% of the polymer species in an IHPC has a particle size of less than about 1500 microns. In one or more aspects, equal to or greater than about 5% of the polymer species in an IHPC has a particle size of less than about 1500 microns. In layman's terms, at these percentages of particles having a size of less than about 1500 microns, this means at least one of the streams contains a significant amount of polymer powder or is in powder form.

In other aspects, the IHPC may be a blend of a reactor powder (i.e., virgin polypropylene) and a pellet designated an IHPC-RP or both components may be pellets and the IHPC in this instance is designated IHPC-P2. In one or more aspects, the IHPC-RP has a particle size distribution greater than about 10× that of the individual constituents (i.e., virgin pellet or recycled polymer) additionally or alternatively, greater than about 25×, additionally or alternatively, greater than about 40×. In one or more aspects, the IHPC-RP has a D5 of less than about 2000 microns or micrometers (μm). In one or more other aspects, a blend of reactor powder (i.e., virgin polymer) and pellet (e.g., MRP) has a D5 from about 5 μm to about 1990 μm, additionally or alternatively from about 10μ to about 1800μ, additionally or alternatively from about 50 μm to about 1500 μm. In one or more aspects, the IHPC-RP has D95/D5 of from about 2 to about 50, additionally or alternatively from about 5 to about 50, additionally or alternatively from about 10 to about 50. In one or more aspects, the IHPC-RP has a D90/D10 of from about 1.35 to about 30, additionally or alternatively from about 2.5 to about 30, additionally or alternatively from about 5 to about 30. In one or more aspects, the IHPC-RP has a broad span of from about 0.6 to about 20, additionally or alternatively from about 2 to about 20, additionally or alternatively from about 5 to about 20. In one or more aspects, the IHPC-RP has a span of from about 0.3 to about 10, additionally or alternatively from about 1 to about 10, additionally or alternatively from about 2 to about 10.

D5 refers to the 5% of particles that are smaller than this size D10 refers to the 10% of particles that are smaller than this size. D50 refers to the 50% of particles that are smaller than this size. D90 refers to the 90% of particles that are smaller than this size. D95 refers to the 95% of particles that are smaller than this size. D90/D10 is a ratio that indicates the breadth of particle sizes within a particle size distribution. D95/D5 is a ratio that indicates the breadth of particle sizes within a particle size distribution, focusing on the very largest and very smallest particles. Span is a dimensionless parameter in particle size analysis that measures the width or spread of a particle size distribution (PSD), indicating the uniformity of a sample. Span can be calculated using the formula: (D90−D10)/D50. Broad Span is a formula for particle size distribution that places emphasis on the very largest and very smallest particles: (D95−D5)/D50. Probability Mass Function (PMF) refers to the probability for individual discrete outcomes while mode refers to the peak of the frequency distribution, such as the largest value within a PMF.

In one or more aspects, the IHPC-P2 has D95/D5 from about 1.25 to about 1.75, additionally or alternatively from about 1.3 to about 1.75, additionally or alternatively from about 1.5 to about 1.75. In one or more aspects, the IHPC-P2 has a D90/D10 of from about 1.2 to about 1.5, additionally or alternatively from about 1.25 to about 1.5, additionally or alternatively from about 1.3 to about 1.45. In one or more aspects, the IHPC-P2 has a broad span of from about 0.25 to about 0.5, additionally or alternatively from about 0.3 to about 0.5, additionally or alternatively from about 0.35 to about 0.5. In one or more aspects, the IHPC-P2 has a span of from about 0.20 to about 0.5, additionally or alternatively from about 0.25 to about 0.45, additionally or alternatively from about 0.25 to about 0.4.

In one or more aspects, an IHPC is characterized by one of more of the following parameters which are all compared to the reference unless specified otherwise. In one or more aspects, an IHPC has an improvement in the color as reflected in a decrease in the Hunter color b value of from about 0.1 to about 7.0, additionally or alternatively, from about 0.1 to about 5.0, additionally or alternatively, from about 0.1 to about 3.0 as determined in accordance with ASTM D6290-19. In general, the Hunter color b value refers to units of light reflectance measurement, where b* represents the axis yellow/blue (+b=yellow, −b=blue).

In one or more aspects, an IHPC has a decrease in yellowness as reflected by a decrease in the Yellowness index value of from about 0.1 to about 20.0, additionally or alternatively, from about 0.1 to about 15.0, additionally or alternatively, from about 0.1 to about 10.0 as determined in accordance with ASTM D6290-19 and/or ASTM E313-96 (D65).

In one or more aspects, an IHPC when formed into a specimen having a 40 mil thickness exhibits a decrease in haze (i.e., increase in clarity) of from about 1.0 to about 60.0, additionally or alternatively from about 1.0 to about 40.0, additionally or alternatively, from about 1.0 to about 25.0 as determined in accordance with ASTM D1003. Herein, the term “haze” refers to the percentage of incident light scattered by more than 2.5° through the plastic specimen.

In one or more aspects, an IHPC has an improvement in the retention of higher molecular weight species following a thermal event such as extrusion. Improvement in the retention of higher molecular weight species can be observed after n extrusion events where n is equal to or greater than 2, additionally or alternatively equal to or greater than 3, additionally or alternatively equal to or greater than 4. Herein, the extent to which higher molecular weight species is retained by the composition will be reflected as variations in the weight average molecular weight (Mₙ), the z-average molecular weight, the polydispersity index or combinations thereof when compared to the reference. The term “higher molecular weight” herein refers to polymer species having M_{w} which are greater than at least 80% of the other polymer species in the material. The number-average molecular weight (Mₙ) refers to the number of polymers having a given mass, then averaged over the total count of the polymer chains. The weight-average molecular weight (M_{w}) refers to the number of chains on the mass of the polymer chains of mass Mᵢ. The z-average molecular weight (M_{z}) is a measure of the average molar mass of a polymer sample, weighted by the cube of the molecular weight. The peak molecular weight (Mₚ) is the mode of the molecular weight distribution; it is the molecular weight of the highest peak.

Improvement in the retention of higher molecular weight species can be evidenced by the M_{w} of the IHPC varying from that of the reference by from about 10% to about 40%, additionally or alternatively, from about 12% to about 35%, additionally or alternatively, from about 15% to about 30%.

Improvement in the retention of higher molecular weight species can be evidenced by the M_{z} of the IHPC varying from that of the reference by from about 30% to about 60%, additionally or alternatively, from about 35% to about 60%, additionally or alternatively, from about 40% to about 60%.

Improvement in the retention of higher molecular weight species can be evidenced by the polydispersity prime (D′) of the IHPC varying from that of the reference by from about 0.01 to about 5.00, additionally or alternatively, from about 0.01 to about 4.00, additionally or alternatively, from about 0.01 to about 2.0 as determined in accordance with gel permeation chromatography (GPC) as described in ASTM D6474-20. Polydispersity prime (D′) which is determined by dividing the M_{z} by M_{w}.

For example, the improved retention in higher molecular species by an IHPC following additional extrusion events could be evidenced (i) an increase in M_{w} retention by comparing M_{w} made using the improved process versus the Me made using the standard process. The increase in M_{w} retention may range from about 0.1% to 50%, additionally or alternatively, from about 0.1% to 30%, additionally or alternatively, from about 0.1% to 20%. A third method is in the increase in z-average molecular weight retention by comparing M_{z} made using the improved process versus the M_{z} made using the standard process. The increase in M_{z} retention is from about 0.1% to 75%, additionally or alternatively, from about 0.1% to 50%, additionally or alternatively, from about 0.1% to 35%.

In one or more aspects, an IHPC displays melt flow stability as reflected in a change in the melt flow rate as a function of passes through the extruder of from about 0%/pass to about 15%/pass, additionally or alternatively, from about 0%/pass to about 13%/pass, additionally or alternatively, from about 0%/pass to about 12%/pass.

In some aspects, an IHPC displays a reduction in the energy consumption required for production of the composition as indicated by an energy savings in extrusion and logistics. The energy savings may range from about 1100 KJ/kg for an IHPC made with 90% virgin PP powder and 10% recyclate to about 124 KJ/kg for an IHPC made with 10% virgin PP powder and 90% recyclate. This energy savings is commercially relevant; in a high cost energy environment it can be equal to or greater than about $0.12/kg.

The aforementioned schematics illustrate a representative hybrid polymer manufacturing process and an improved hybrid polymer manufacturing process. The improved hybrid polymer manufacturing processes disclosed herein are simpler as these processes eliminate an extrusion and shipping step, ensuring the virgin polymer powder in the hybrid formulation experiences only one melt history. Further, the disclosed processes for preparing an IHPC are in line with present polymer reactor configurations allowing process adjustments to be made to the reactor to adjust molecular architecture in real time. This is an element of manufacturing control, making in-line molecular weight adjustments, that does not exist in conventional hybrid pellet production.

In one or more aspects, the virgin polymer is first compounded into a pellet. In such aspects, the pellet is then sent to a third-party compounder, where it is physically mixed with recyclate and melt extruded. Advantageously the present disclosure allows the user to adjust the hybrid composition in the event the hybrid composition possesses suboptimal properties due to the virgin polymer being suboptimal. The presently disclosed processes provide for a built-in agility for real-time adjustments that reduces quality control risk. The presently disclosed processes also advantageously allow for additive adjustments to be made in real time, reducing manufacturing risk by ensuring the IHPC has the requisite additive concentration. This attribute may be utilized in order to ensure sufficient active antioxidants are available or for formulations that contain additives which can be easily degraded, such as certain clarifiers.

The presently disclosed processes also provide for a distinct particle size introduced into the extrusion step, particularly when compared with industrial-scale in-line virgin polyolefin extrusion and third-party compounding. The presently disclosed IHPC powder has smaller particle size than typical pellets, has a broad distribution of sizes and often has an irregular shape that leads to less efficient packing. The extent to which there is less efficient packing may be quantified thru measurements such as lower bulk density.

The presently disclosed compositions and method involve comingling polyolefin reactor powder with at least one additional polymer stream that has already experienced at least one melt history. One aspect is comingling reactor powder with extruded pellets. In one or more aspects, the IHPC is prepared by comingling reactor powder with polymer regrind (plastic parts that have been shredded to reduce their size for reintroduction into polymer converting operations). Each comingled stream has a discrete particle size distribution, so the polymer stream feed into the improved hybrid process at the extrusion step is multimodal (i.e., has two or more discrete polymer particle size distributions), with one of those distributions being from polyolefin reactor powder that has not undergone a melting heat history.

The particle size distribution used in this improved process is differentiated from either 1) industrial scale virgin polyolefin extrusion or 2) traditional hybrid single pellet production. However, this improved hybrid polyolefin recyclate compounding process, regardless of pathway, has generalizing features that significantly differentiate it from the traditional method: At least one polymer stream, consisting of between 10% to 90% of the final hybrid recyclate compound, is polyolefin reactor powder that has not experienced a melt history prior to the hybrid recyclate compounding step. Disclosed herein is a hybrid polymer produced using the new process. In one or more aspects, the IHPC is prepared by a method comprising physically blending virgin polypropylene reactor powder that has seen no melt extrusion history with recyclate polypropylene then melt mixing this physical blend through an extrusion step and pelletizing the mixture.

### ADDITIONAL DISCLOSURE

The following are nonlimiting aspects of the presently disclosed subject matter:

A first aspect which is a hybrid polymer composition comprising (i) equal to or greater than about 10 wt. % of one or more mechanically recycled polymers and (ii) one or more polypropylene powders. The polypropylene powder has a single melt history.

A second aspect which is the composition of the first aspect wherein the composition comprises equal to or greater than about 30 wt. % of the one or more mechanically recycled polymer.

A third aspect which is the composition of any of the first through second aspects wherein the composition comprises equal to or greater than about 50 wt. % of the one or more mechanically recycled polymer.

A fourth aspect which is the composition of any of the first through third aspects wherein the one or more mechanically recycled polymers has equal to or greater than about 3 melt histories.

A fifth aspect which is the composition of any of the first through fourth aspects wherein the one or more mechanically recycled polymers, the one or more polymer powders or both comprise thermoplastic polymers.

A sixth aspect which is the composition of any of the first through fifth aspects wherein the one or more mechanically recycled polymers, the one or more polymer powders or both comprise polyolefins.

A seventh aspect which is the composition of any of the first through sixth aspects wherein the one or more mechanically recycled polymers, the one or more polymer powders or both comprise a propylene polymer.

An eighth aspect which is the composition of any of the first through seventh aspects having MFR retention within 12% of the initial value after experiencing 1 additional melt history.

A ninth aspect which is the composition of any of the first through eight aspects having a haze of less than 40% in a specimen having a 40 mil thickness.

A tenth aspect which is a method of preparing a hybrid polymer composition comprising contacting a virgin polypropylene reactor powder with a mechanical recyclate polymer wherein the virgin polypropylene reactor powder has a single melt history.

An eleventh aspect which is the method of the tenth aspect wherein the hybrid polymer composition comprises equal to or greater than about 10 wt. % of the one or more recyclate polymers.

A twelfth aspect which is the method of any of the tenth through eleventh aspects wherein the hybrid polymer composition comprises equal to or greater than about 30 wt. % of the one or more recyclate polymers.

A thirteenth aspect which is the method of any of the tenth through twelfth aspects wherein the hybrid polymer composition comprises equal to or greater than about 50 wt. % of the one or more recyclate polymers.

A fourteenth aspect which is the method of any of the tenth through thirteenth aspects wherein the one or more recyclate polymers have equal to or greater than about 3 melt histories.

A fifteenth aspect which is the method of any of the tenth through fourteenth aspects wherein the one or more recyclate polymers, the one or more virgin polymer powders or both comprise thermoplastic polymers.

A sixteenth aspect which is the method of any of the tenth through fifteenth aspects wherein the one or more recyclate polymers, the one or more virgin polymer powders or both comprise polyolefins.

A seventeenth aspect which is the method of any of the tenth through sixteenth aspects wherein the one or more recyclate polymers, the one or more virgin polymer powders or both comprise a propylene polymer.

An eighteenth aspect which is a hybrid polymer composition comprising (i) equal to or greater than about 10 wt. % of one or more mechanically recycled polymers and (ii) polypropylene wherein the polypropylene has a single melt history.

A nineteenth aspect which is the composition of the eighteenth aspect wherein the composition comprises from about 30 wt. % to about 50 wt. % of the one or more mechanically recycled polymer.

A twentieth aspect which is the composition of any of the eighteenth through nineteenth aspects wherein the one or more mechanically recycled polymers has equal to or greater than about 3 melt histories.

A twenty-first aspect which is the composition of any of the eighteenth through twentieth aspects wherein the one or more mechanically recycled polymers, comprise a polypropylene.

A twenty-second aspect which is the composition of any of the eighteenth through twenty-first aspects having a melt flow rate change of from about 0%/number of passes through an extruder to about 15%/number of passes through an extruder.

A twenty-third aspect which is the composition of any of the eighteenth through twenty-second aspects wherein the polypropylene is in the form of a reactor powder or a pellet.

A twenty-fourth aspect which is the composition of any of the eighteenth through twenty-third aspects wherein the polypropylene is in the form a reactor powder and the mechanically recycled polymer is in the form of a pellet.

A twenty-fifth aspect which is the composition of any of the eighteenth through twenty-fourth aspects wherein both the polypropylene and the mechanically recycled polymer are in the form of a pellet.

A twenty-sixth aspect which is the composition of the twenty-third aspect having a D5 of equal to or less than about 2000 microns.

A twenty-seventh aspect which is the composition of the twenty-sixth aspect having a D95/D5 of from about 2 to about 50.

A twenty-eighth aspect which is the composition of any of the twenty-sixth through twenty-seventh aspects having a D90/D10 of from about 1.35 to about 30.

A twenty-ninth aspect which is the composition of any of the twenty-sixth through twenty-eighth aspect having a broad span of from about 0.6 to about 20.

A thirtieth aspect which is the composition of any of the twenty-sixth through twenty-ninth aspects wherein the composition has a span of from about 0.3 to about 10.

A thirty-first aspect which is the composition of the twentieth-fourth aspect having a D95/D5 of from about 1.25 to about 1.75.

A thirty-second aspect which is the composition of the thirty-first aspect having a D90/D10 of from about 1.2 to about 1.5.

A thirty-third aspect which is the composition of any of the thirty-first through thirty-second aspects through thirty-third aspect, having a broad span of from about 0.25 to about 0.5.

A thirty-fourth aspect which is the composition of any of the thirty-first through thirty-third aspects having a span of from about 0.2 to about 0.5.

A thirty-fifth aspect which is a method of preparing a hybrid polymer composition comprising contacting a virgin polypropylene reactor powder with a mechanical recyclate polymer wherein the virgin polypropylene reactor powder has a single melt history.

A thirty-sixth aspect which is the method of the thirty-fifth aspect wherein the hybrid polymer composition comprises equal to or greater than about 10 wt. % of the one or more recyclate polymers.

A thirty-seventh aspect which is the method of any of the thirty-fifth through thirty-sixth aspects wherein the hybrid polymer composition when formed into a specimen has a decrease in the Hunter color b value of from about 0.1 to about 7.0 when compared to an otherwise similar specimen formed from a virgin polypropylene having more than one melt history.

A thirty-eighth aspect which is the method of any of the thirty-fifth through thirty-seventh aspects wherein the hybrid polymer composition when formed into a specimen with a 40 mil thickness has a decrease in haze of from about 1.0 to about 60.0 when compared to an otherwise similar.

A thirty ninth aspect which is a method comprising extruding a virgin polymer to form an article; using and disposing of the article to produce a disposed article; recovering and cleaning the disposed article to form a cleaned article; shredding the cleaned article to form a shredded article; regrinding the shredded article to form a regrind recyclate; contacting the regrind recyclate with a virgin polymer powder to form a mixture; and; extruding the mixture to form a hybrid extrusion wherein the virgin polymer pellet, the virgin polymer powder or both comprise polypropylene.

### EXAMPLES

The aspects having been generally described, the following examples are given as particular aspects of the disclosure and to demonstrate the practice and advantages thereof. It is understood that the examples are given by way of illustration and are not intended to limit the specification of the claims in any manner.

### Example 1

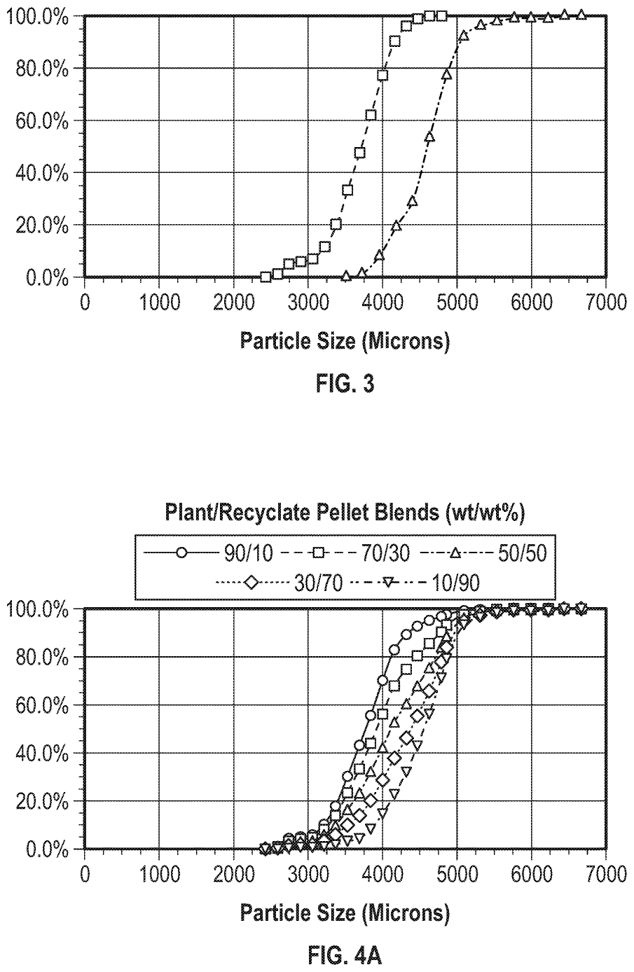

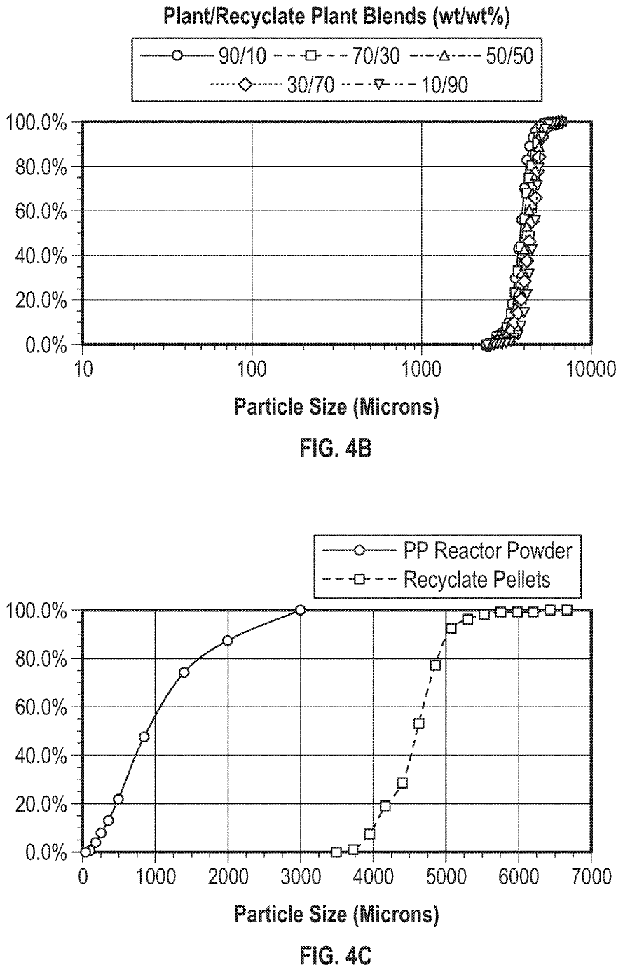

For traditional hybrid single pellet compounds, the plant pellets were mixed with recyclate. The recyclate was typically also provided in pellet form. Two representative cumulative distributions are shown in FIG. 3. The resulting pellet/pellet blend generated a bimodal particle size distribution but only in a mild sense. The pellet size ranges are similar between recyclate pellets and plant pellets, normally at ~2×, FIG. 4A. This is readily seen when particle size is plotted on a log scale for cumulative distributions over a blend range of 90/10 wt. % to 10/90 wt. % plots of the Plant Pellet/Recyclate collapse closely onto each other, FIG. 4B.

The tight cumulative distribution range over a broad spectrum of pellet/pellet blend compositions intuitively makes sense. Recyclate pellets must have a shape and size distribution to work on existing customers converting equipment. Traditional hybrid recyclate compounds are optimized around this approach, where regardless of the pellet streams being provided, they behave similarly with regards to processes such as feeding in extrusion systems and bulk density for pneumatic transport. The particle size distribution within the polymer is such that the particle size of the largest pellet formed is 10× greater than that of the smallest particle, additionally or alternatively 5× greater.

The cumulative size distributions of reactor powder and recyclate pellets for an IHPC is illustrated in FIG. 4C. With reference to FIG. 4C, there is negligible overlap in sizes with the largest reactor particles are marginally within the same range as the smallest pellets. The size distribution differences between various products is modest: most reactor powders will have a similar size distribution and likewise for most extruded pellets. This size difference is much larger than what one finds in traditional hybrid recyclate compounding.

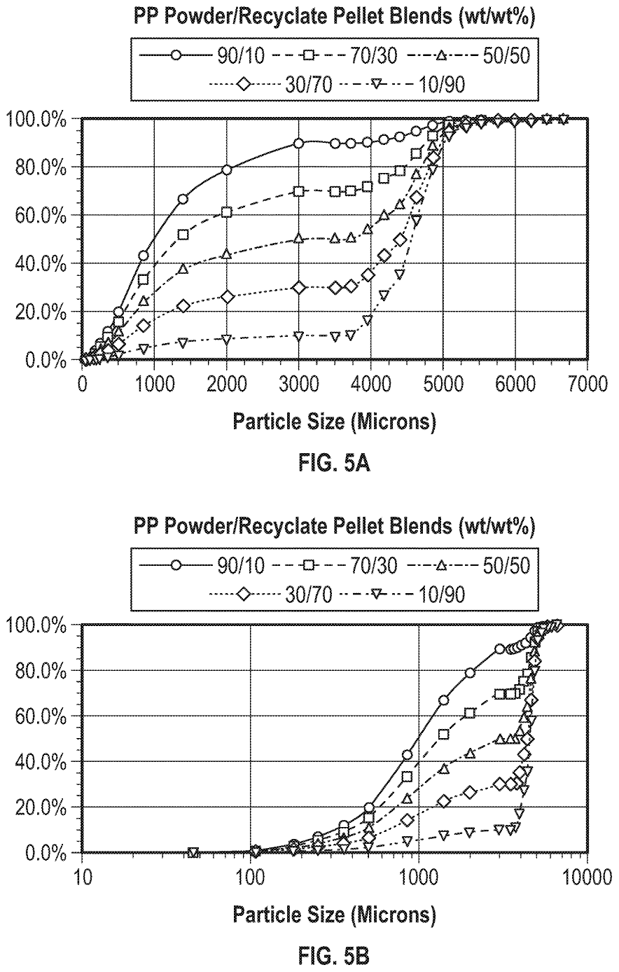

The particle size distribution for mixtures of PP powder-recyclate mixtures at the indicated weight percentages are plotted on different scales in FIGS. 5A and 5B.

### Example 2

A commercial-scale test of the IHPC was carried out. The purpose was two-fold: 1) to confirm operational consistency and control and 2) to create product for property characterization to affirm commercial utility.

The multipass extrusion work was done on two hybrid recycled PP compounds. The first was an extruded pellet/pellet blend and designated as the baseline. Specifically, virgin PP pellets were comingled with Banyan 1582 recyclate at a 70%/30% loading, fed into an app lab extruder where they were both melted and mixed, after which the melt mixture was pumped through a die orifice and cut into pellets. This pellet/pellet blend represents current industry practice with third-party compounding.

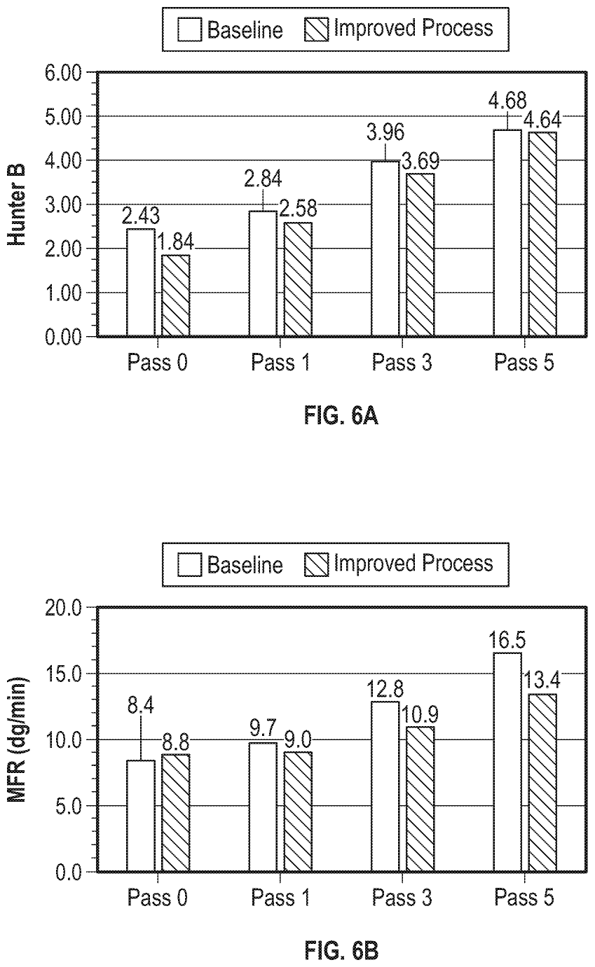

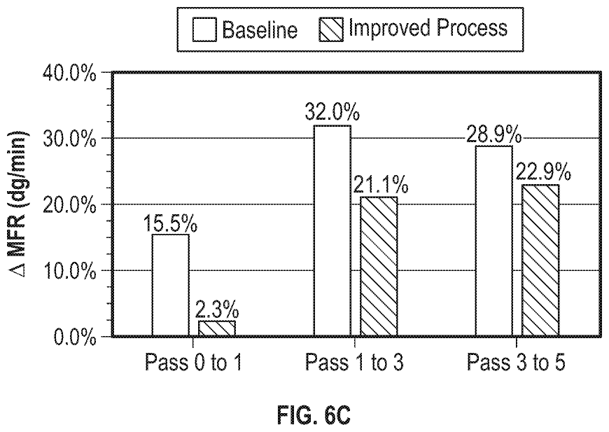

The second hybrid composition, an IHPC, designated improved, was an extruded reactor powder/pellet blend. Specifically, fresh reactor powder was comingled in-line with Banyan 1582 recyclate at a 70/30% loading, fed into an extruder where both the reactor powder and pellets were melted and mixed, after which the melt mixture was pumped through a die orifice and cut into pellets. BANYAN 1582 is a recycled polypropylene commercially available from Banyan plastics. This reactor powder/pellet blend (IHPC) is a less complex process and subjects the virgin polymer portion of the composition to only one melt history. The improved process material (i.e., IHPC) displayed an improved color as evidenced by the Hunter B values presented in FIG. 6A. The improvement in melt flow rate stability is illustrated in FIGS. 6B and 6C.

### Example 3

Lab compounds were produced using the traditional two-step process and the improved one-step process. These grades were nucleated with NX8000 clarifier, because clarifiers can be sensitive to thermal history and clarity is often a functional attribute in customer applications. The results are presented in Table 1 where samples 1-3 were prepared using the baseline polymer and samples 4-6 were prepared using the recyclate PP and powder.

The results were positive, with the improved process yielding (i) improved color (lower Hunter b, lower Yellowness Index); (ii) improved clarity (lower haze values); (iii) improved retention of high molecular weight species (especially seen in higher weight-average molecular weight and z-average molecular weight).

TABLE 1

| | | Sample 1 | Sample 2 | Sample 3 | Sample 4 | Sample 5 | Sample 6 |
|---|---|---|---|---|---|---|---|
| | | Traditional-Process (two-steps) | | | Improved-Process (one-step) | | |
| | | Virgin PP | Virgin PP | Virgin PP | Virgin PP | Virgin PP | Virgin PP |
| | | Pellet/rPP | Pellet/rPP | Pellet/rPP | Fluff/rPP | Fluff/rPP | Fluff/rPP |
| | | Pellet | Pellet | Pellet | Pellet | Pellet | Pellet |
| Property Analysis | | (50% AO) | (100% AO) | (150% AO) | (50% AO) | (100% AO) | (150% AO) |
| MFR | g/10 min | 41.5 | 35.8 | 21.8 | 20.6 | 20.5 | 17.0 |
| Color (L/a/b/YI) | — | 72.9/−1.7/ | 69.9/−1.4/ | 70.3/−0.9/ | 72.7/−0.9/ | 72.3/−0.5/ | 70.8/−0.7/ |
| | | 4.2/8.5 | 2.2/3.9 | −0.8/−2.9 | 0.1/−0.9 | −1.7/−4.8 | −1.8/−5.3 |
| Recrystalli- | ° C. | 121.3 | 124.7 | 131.6 | 120.2 | 125.5 | 130.5 |
| zation Peak | | | | | | | |
| Melt Peak | ° C. | 165.1 | 164.9 | 166.5 | 165.1 | 165.5 | 166.9 |
| % Crystallinity | % | 48.1 | 53.9 | 56.8 | 50.6 | 50.9 | 52.0 |
| Haze (0.04″ | % | 64.3% | 50.1% | 23.8% | 59.4% | 35.3% | 19.6% |
| thick plaque) | | | | | | | |
| Haze (0.06″ | % | 81.7% | 69.5% | 31.8% | 78.1% | 52.6% | 28.2% |
| thick plaque) | | | | | | | |
| Tensile | Psi | 5459 | 5744 | 5903 | 5464 | 5811 | 5875 |
| Strength @ | | | | | | | |
| Yield | | | | | | | |
| Tensile | % | 5.6% | 5.2 | 4.8 | 5.8 | 5.0 | 4.7 |
| Elongation @ | | | | | | | |
| Yield | | | | | | | |
| Flex Modulus | Kpsi | 241 | 258 | 283 | 238 | 272 | 288 |
| Tensile Modulus | Kpsi | 279 | 301 | 321 | 278 | 310 | 321 |
| Mₙ | g/mol | 23467 | 19471 | 21053 | 28575 | 28457 | 27533 |
| M_{w} | g/mol | 156252 | 162047 | 188310 | 212248 | 214671 | 222774 |
| M_{z} | g/mol | 407298 | 429905 | 546201 | 700783 | 724541 | 795759 |
| MWD | — | 6.66 | 8.32 | 8.94 | 7.43 | 7.5 | 8.09 |

### Example 4

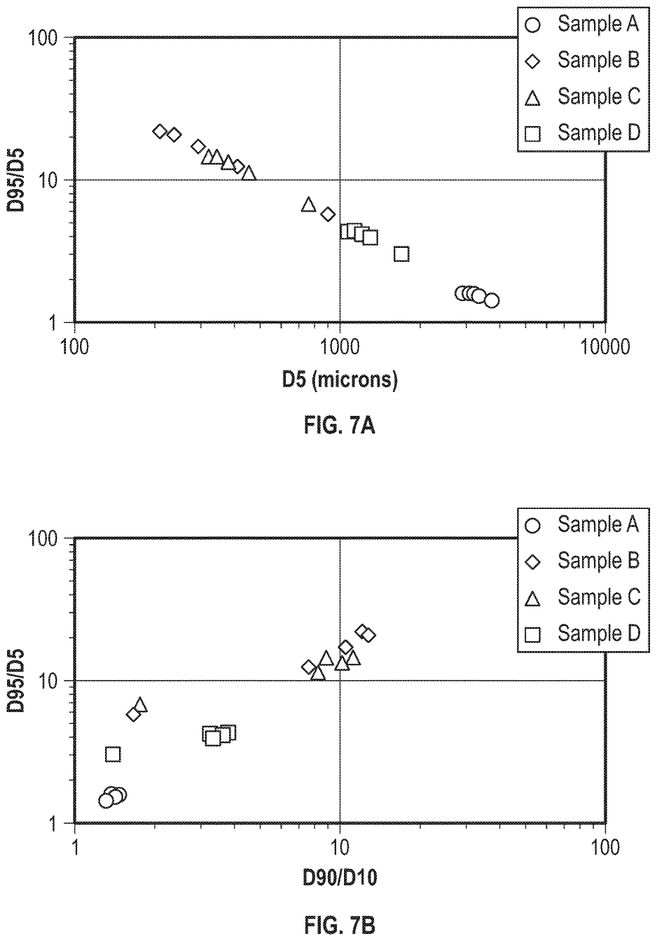

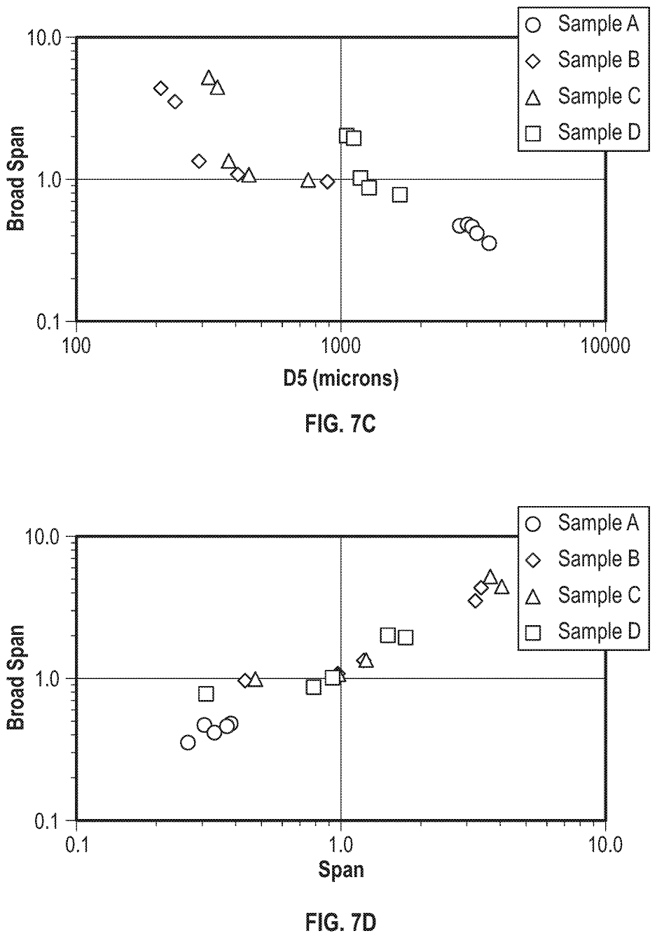

The particle sizes having IHPC blends having MPR to virgin polymer powder ratios ranging from 10 wt. %: 90 wt. % to 90 wt. %: 10 wt. % loading levels. Each sample contained the indicated amount of Banyan 1582. Sample A is an IHPC which is a blend of the virgin polymer LX 24-12 which is a hybrid random copolymer polypropylene pellet having 8 MFR, 4.5% xylene solubles, 3.0% ethylene and 30 wt. % Banyan 1582. Sample B is an IHPC which is a blend of the virgin polymer 7250FL which is a polypropylene Ziegler-Natta random copolymer with a 1.45 MFR, 2.7% ethylene, 4.5% xylene solubles and 30 wt. % Banyan 1582. Sample C is an IHPC which is a blend of the virgin polymer M3766 which is a metallocene polypropylene homopolymer with a 24 MFR and less than 1% xylene solubles and 30 wt. % Banyan 1582. Sample D is an IHPC which is a blend of the virgin polymer 3962 which is a Ziegler-Natta h polypropylene homopolymer with a 100 MFR and less than 3.0% xylene solubles and 30 wt. % Banyan 1582. 7250FL is a polypropylene random copolymer. M3766 is a metallocene homopolymer, 3962 is a Ziegler-Natta homopolymer; all of which is commercially available from TotalEnergies. The results are shown in FIGS. 7A, 7B, 7C and 7D which are plots of the D5/D95 as a function of D5, D95/D5 as a function of D90/D10, Broad Span as a function of D5 and Broad Span as a function of span. Mapping illustrates how reactor powder/recyclate pellet blends differ from pellet/pellet blends. In this disclosure mapping results illustrate how Sample A which is a pellet/pellet blend prepared using a conventional method of making hybrid recyclate compounds lies in a separate domain space than the IHPC-based materials which are the subject matter of the present disclosure. Pellet/pellet feeding is different than powder/pellet feeding in industrial operation and these differences are nontrivial. More specifically, powder behavior is directly influenced by particle size and this influences the industrial application. With reference to FIGS. 7A and 7C, mapping with D5 on the x-axis illustrates there are a significant number of very small species present. This is material because the particle size distribution, particularly with small, powdery materials, can influence bulk density, solids conveying, and other process operations. With regard to FIGS. 7B and 7D, recall that Broad Span=(D95−D5)/D50 while Span=(D90−D10)/D50. These figures are another way to represent the low and high particle size “tails” within the distribution, illustrating the IHPC-based blends being fed into extrusion are strongly differentiated from what is conventional practice in making hybrid recyclate compounds.

While preferred aspects have been shown and described, modifications thereof can be made by one skilled in the art without departing from the scope or teachings herein. The aspects described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the aspects described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein. In the event of conflict, the present specification, including definitions, is intended to control.

What is claimed is:

1. A hybrid polymer composition, comprising:
(i) equal to or greater than about 10 wt. % of one or more mechanically recycled polymers; and
(ii) polypropylene wherein the polypropylene has a single melt history.

2. The hybrid composition of claim 1, wherein the composition comprises from about 30 wt. % to about 50 wt. % of the one or more mechanically recycled polymer.

3. The hybrid composition of claim 1, wherein the one or more mechanically recycled polymers has equal to or greater than about 3 melt histories.

4. The hybrid polymer composition of claim 1, wherein the one or more mechanically recycled polymers, comprise a polypropylene.

5. The hybrid polymer composition of claim 1, having a melt flow rate change of from about 0%/number of passes through an extruder to about 15%/number of passes through an extruder.

6. The hybrid composition of claim 1, wherein the polypropylene is in the form of a reactor powder or a pellet.

7. The hybrid composition of claim 6, wherein the polypropylene is in the form a reactor powder and the mechanically recycled polymer is in the form of a pellet.

8. The hybrid composition of claim 6, wherein both the polypropylene and the mechanically recycled polymer are in the form of a pellet.

9. The hybrid composition of claim 7, having a D5 of equal to or less than about 2000 microns.

10. The hybrid composition of claim 7, having a D95/D5 of from about 2 to about 50.

11. The hybrid composition of claim 7, having a D90/D10 of from about 1.35 to about 30.

12. The hybrid composition of claim 7, having a Broad Span of from about 0.6 to about 20.

13. The hybrid composition of claim 7, having a Span of from about 0.3 to about 10.

14. The hybrid composition of claim 8, having a D95/D5 of from about 1.25 to about 1.75.

15. The hybrid composition of claim 8, having a D90/D10 of from about 1.2 to about 1.5.

16. The hybrid composition of claim 8, having a Broad Span of from about 0.25 to about 0.5.

17. The hybrid composition of claim 8, having a Span of from about 0.2 to about 0.5.

18. A method of preparing a hybrid polymer composition comprising:
contacting a virgin polypropylene reactor powder with a mechanical recyclate polymer, wherein the virgin polypropylene reactor powder has a single melt history.

19. The method of claim 18, wherein the hybrid polymer composition comprises equal to or greater than about 10 wt. % of the one or more recyclate polymers.

20. The method of claim 18, wherein the hybrid polymer composition when formed into a specimen has a decrease in the Hunter color b value of from about 0.1 to about 7.0 when compared to an otherwise similar specimen formed from a virgin polypropylene having more than one melt history.

21. The method of claim 18, wherein the hybrid polymer composition when formed into a specimen with a 40 mil thickness has a decrease in haze of from about 1.0 to about 60.0 when compared to an otherwise similar specimen formed from a virgin polypropylene having more than one melt history.

22. A method comprising:
extruding a virgin polymer pellet to produce an article;
using and disposing of the article to produce a disposed article;
recovering and cleaning the disposed article to form a cleaned article;
shredding the cleaned article to form a shredded article regrinding the shredded article to form a regrind recyclate;
contacting the regrind recyclate with a virgin polymer powder to form a mixture; and;
extruding the mixture to form a hybrid extrusion wherein the virgin polymer pellet, wherein the virgin polymer powder or both comprise polypropylene.
